(19) United States
(12) Patent Application Publication
(10) Pub. No.: US 2005/0044018 A1
(43) Pub. Date: Feb. 24, 2005

(54) Variable-rate cellular telephone billing method

(76) Inventor: Jean E. Whewell, Georgetown, TX (US)

Correspondence Address: Christopher J. Whewell;Western Patent Group, 6020 Tonkowa Trail, Georgetown, TX, 78628, US

(21) Appl. No.: 10/964,535

(22) Filed: Oct. 13, 2004

(51) Int. Cl. G06F 17/60

(52) U.S. Cl. 705/34

(57) ABSTRACT

Provided herein is a variable billing plan which calculates the lowest possible invoice amount to be billed to a consumer of cellular services from a variety of billing options. Through use of a billing method according to the invention, consumer loyalty is increased at negligible expense to bandwidth consumption.

### CROSS-REFERENCES TO RELATED APPLICATIONS

The present application claims priority to U.S. patent application Ser. No. 10/230,852 filed on Aug. 29, 2002, currently still pending.

### TECHNICAL FIELD

This invention relates to cellular telephone service and billing plans useful by providers of such service to invoice their customers for such service.

### BACKGROUND

Cellular telephone services are in widespread use. Providers of such services offer different billing plans to prospective customers under which the different plans have differing amounts of threshold levels of minutes that a user may consume for a flat fee. If the user exceeds the threshold amount of plan minutes within a given billing cycle, the user must pay a rate per minute for minutes in excess of the plan amounts. Often, the rate per minute for minutes used in excess of the plan threshold level of minutes is punitive in a sense that it is much higher than the rate per minute calculated from the basic plan amount divided by the number of threshold minutes provided under such a plan. This puts the consumer at a disadvantage as far as cost is concerned with respect to minutes consumed beyond the plan amount, and my cause negative feelings in the mind of the consumer towards the service provider, thus causing the consumer to break a contract or to seek alternative sources of cellular services after expiry of a contract. What is needed therefore, is a billing plan which does not penalize consumers for excessive use of cellular services and which increases consumer loyalty to a provider of cellular services.

### BRIEF DESCRIPTION OF THE DRAWINGS

In the annexed drawings,

FIG. 1 is a flowchart showing the steps of a billing plan according to one form of this invention;

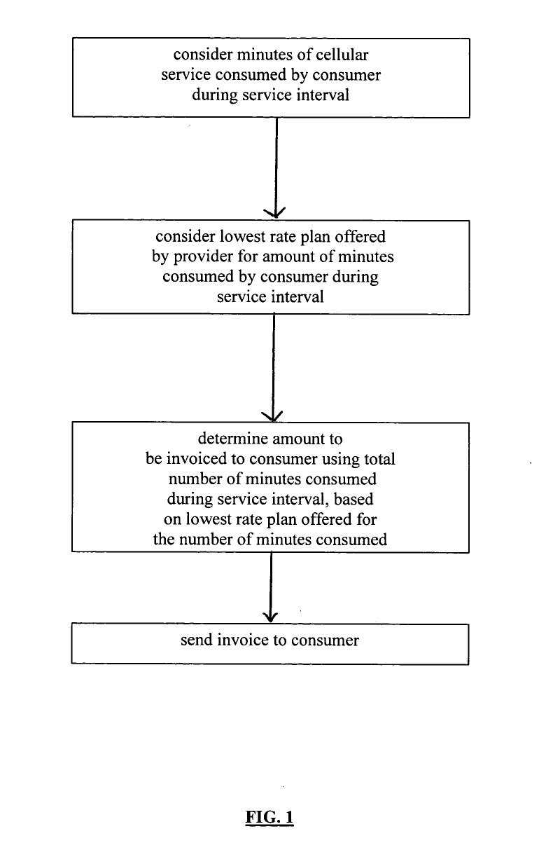

FIG. 2 is the graphical equivalent of billing plan 1 specified in Table I;

FIG. 3 is the graphical equivalent of billing plan 2 specified in Table I;

FIG. 4 is the graphical equivalent of billing plan 3 specified in Table I;

FIG. 5 is the graphical equivalent of billing plan 5 specified in Table I;

FIG. 6 is the graphical equivalent of billing plan 6 specified in Table I;

FIG. 7 is the graphical equivalent of billing plan 4 specified in Table I;

FIG. 8 is the graphical equivalent of billing plans 1-6 specified in Table I superimposed on the same graph; and

FIG. 9 is the graphical equivalent of a billing plan according to the present invention.

### SUMMARY OF THE INVENTION

The present invention provides a variable billing plan method for calculating an invoice amount for a consumer of cellular telephone services during a service interval. A method according to the invention comprises the steps of: a) offering a consumer a plurality of billing schedules from which to choose, wherein each of the schedules includes a pre-determined threshold level of given plan minutes which are billed at a flat rate and a rate per minute for each minute of service used which exceeds the threshold level, and wherein each of the plurality of billing schedules offered includes a different amount of pre-determined threshold level of given plan minutes: accepting a billing schedule choice selection from the consumer, wherein the choice includes a pre-determined threshold level of given plan minutes which are billed at a flat rate and a rate per minute for each minute of service used which exceeds the threshold level; c) providing cellular telephone service to the consumer during a service interval; d) calculating an invoice amount based upon the accepted billing schedule choice by combining the total dollar values of the flat rate and an addend that is calculated by multiplying the number of minutes of service used that exceed the threshold level by the rate per minute charged for each minute exceeding the threshold level; e) calculating a hypothetical invoice amount based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected; f) repeating step e) for each of all of the plans offered but not selected, so as to provide a hypothetical invoice amount for each plan not selected; g) comparing the hypothetical invoice amount(s) with the invoice amount from step d) to determine which out of all of the invoice amount and the hypothetical invoice amount(s) is the least dollar value; and h) issuing an invoice to the customer using the least dollar value as a pre-tax basis for the invoice.

### DETAILED DESCRIPTION

Cellular service providers offer the public different billing plans from which each individual user may choose, which best suits their personal calling needs. Typically, such services offer several different billing schedules to prospective customers to entice them to enter into contractual obligations with the service provider. Typically, the billing schedules offered include a pre-determined threshold level of minutes that the consumer may use, in exchange for a flat billing amount. In the event that the consumer utilizes more minutes of cellular service than specified as the predetermined threshold level, the consumer is billed on a per-minute basis for each minute in excess of the threshold level of minutes in the plan accepted by the consumer. The invoice at the end of the service interval, which is typically monthly, is calculated by adding the total dollar values of the flat rate and an addend that is calculated by multiplying the number of minutes of service used that exceed the threshold level by the rate per minute charged for each minute exceeding the threshold level. Taxes and other fees may then be added on and a final invoice amount is billed to the consumer.

A typical offering of a plurality of billing schedules is set forth below in Table I:

TABLE I
common plurality of billing schedule options offered to
consumers of cellular service.

| | Monthly Service | Threshold Level of | Additional |
|---|---|---|---|
| Plan Number | Charge | Minutes | Minutes Cost |
| 1 | $ 34.99 | 300 | 40 cents |
| 2 | $ 49.99 | 500 | 40 cents |
| 3 | $ 74.99 | 1000 | 40 cents |
| 4 | $ 99.99 | 1300 | 40 cents |
| 5 | $ 149.99 | 2200 | 40 cents |
| 6 | $ 199.99 | 3200 | 40 cents |

Thus, a consumer operating under plan 1 who used 400 minutes per service interval would be invoiced an amount equal to the monthly service charge of $34.99 plus an additional $40.00, derived from multiplying 100 minutes excessive of the threshold level of 300 minutes times the rate of 40 cents per minute.

Similarly, a consumer operating under plan 1 who used 600 minutes during the service interval would be invoiced based on an amount of $34.99 plus $120.00.

Certainly, it is to the consumer's advantage to select the plan which is well-suited to their individual needs. However, prediction of service usage by consumers is not always accurate due to fluctuating individual needs. If a cellular service provider were to offer their consumers and prospective consumers a variable rate billing plan which saved the consumer money during unpredictable fluctuations in their service, the consumer would appreciate the cost savings that such a variable billing plan would offer. A cellular service provider which offered a variable billing plan according to the invention would be very likely to attract customers away from their competition, and would appreciate significant long-term overall financial gains relative to their competition realized by an increased subscriber base, with relatively little increase in bandwidth usage.

According to the present invention the regular amount that a consumer would be billed under an accepted billing schedule is calculated. Then, a hypothetical invoice amount is calculated based upon a billing plan that was offered to the consumer but which was not selected by the consumer, using the actual minutes of service used by the customer during the service interval, by combining the dollar value for the threshold level of given minutes for the plan not selected, and the rate for each minute in excess of the threshold level for the plan not selected, to arrive at a hypothetical invoice amount for a plan not selected. This is repeated for each of the plans that were offered but not selected, so as to provide a hypothetical invoice amount for each plan not selected. Then, the hypothetical invoice amount(s), (when more than two plans were offered to the consumer) are compared with the regular amount that the consumer would be billed under the accepted billing schedule (the “actual amount”)to determine which dollar value out of all of the hypothetical and actual amounts is the lowest cost to the consumer. The lowest value is selected as a basis for invoicing the customer, to which taxes and other customary fees are added to yield a final invoice amount which must be paid by the consumer.

In one preferred embodiment of the invention, in exchange for the valuable variable billing plan according to the invention, the consumer of cellular services is levied a surcharge on their invoice for the use of the variable plan.

Thus, a consumer of cellular services operating under plan 1 of Table I who uses 400 minutes in the service interval would have an actual amount for billing as set forth in Table III below next to plan 1, with the rest of the dollar values being the hypothetical invoice amounts:

TABLE II
Invoice amounts for person operating under plan 1 from Table I
who uses 400 minutes of service during the service interval.

| Plan Number | Invoice Amounts |
|---|---|
| 1 | $ 74.99 (actual) |
| 2 | $ 49.99 (hypothetical) |
| 3 | $ 74.99 (hypothetical) |
| 4 | $ 99.99 (hypothetical) |
| 5 | $ 149.99 (hypothetical) |
| 6 | $ 199.99 (hypothetical) |

According to the present invention, the dollar figures from the right-hand column of Table II would be compared with one another to discover that the lowest dollar amount is $49.99. This is the amount which would be used as a basis for calculating the consumer's invoice, thus saving the consumer $30.00. The service provider, in one embodiment, would charge the consumer a surcharge for the use of a plan according to the present invention, which could be any amount between 0 and the amount saved. While it is most preferred that the surcharge is about one-half of the savings to the consumer, the present invention contemplates surcharges which are any dollar value between zero and the amount saved through use of the plan.

As another example, a consumer operating under plan 1 in Table I who uses 600 minutes of service would have an actual amount for billing as set forth in Table III below next to plan 1, with the rest of the dollar values being the hypothetical invoice amounts:

TABLE III
Invoice amounts for person operating under plan 1 from Table I
who uses 600 minutes of service during the service interval.

| Plan Number | Invoice Amounts |
|---|---|
| 1 | $ 154.99 (actual) |
| 2 | $ 89.99 (hypothetical) |
| 3 | $ 74.99 (hypothetical) |
| 4 | $ 99.99 (hypothetical) |
| 5 | $ 149.99 (hypothetical) |
| 6 | $ 199.99 (hypothetical) |

Thus, the lowest billing amount for a person operating under plan 1 who uses 600 minutes of service but calculated according to a method of the present invention would be $74.99. This could represent a maximum amount of savings of $80.00 to the consumer.

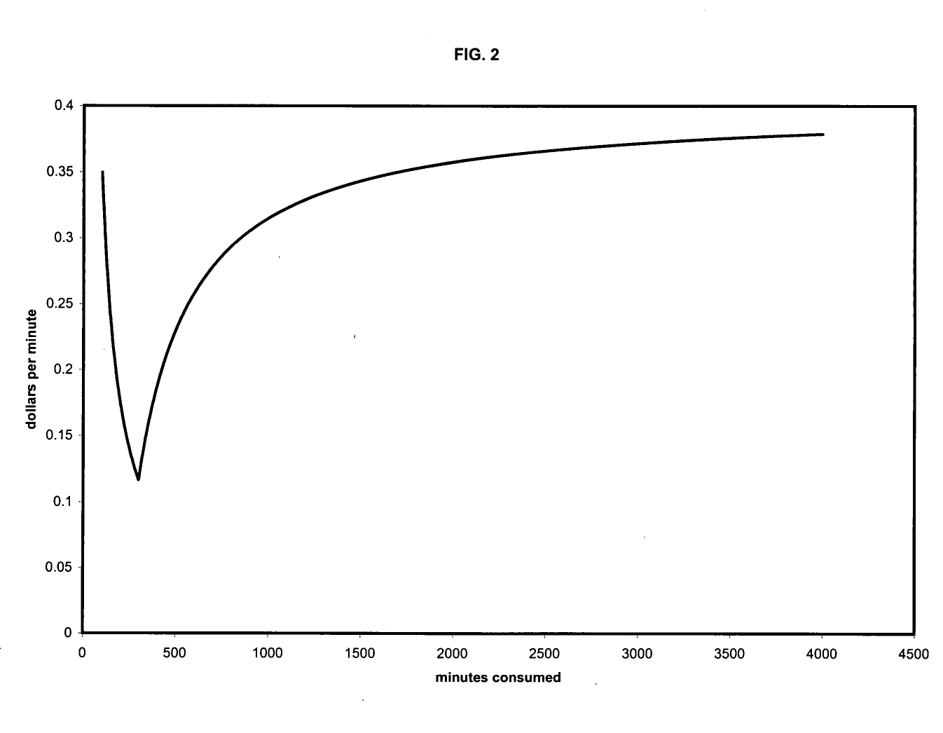

Given the information for Plan 1 in Table I, one of ordinary skill in the art immediately recognizes that under plan 1, for $34.99 the customer may consume any amount of cellular service up to 300 minutes without incurring any additional charges. Beyond the 300-minute threshold they are billed 40 cents per minute for each minute further consumed. FIG. 2 is the graphically equivalent expression of plan 1 as specified in Table I. FIG. 2 shows graphically that the cost per minute of cellular service consumed versus minutes of consumption is an inherent property of Plan 1 in Table I. The overall rate per minute charged for cellular service for the month is calculated by dividing the total dollars invoiced for the service by the number of minutes consumed in the month. To the left of the minimum point in the graph the equivalent mathematical expression for this is 34.99/x. Towards the right of the minimum, the equivalent mathematical expression is calculated according to the formula:
((((x−300)*(0.4)))+34.99)/x
in which the asterisk (*) represents the multiplication operator and x represents the total number of minutes consumed. These expressions are mathematically equivalent expressions of Plan 1 which are inherently contained in the description of Plan 1.

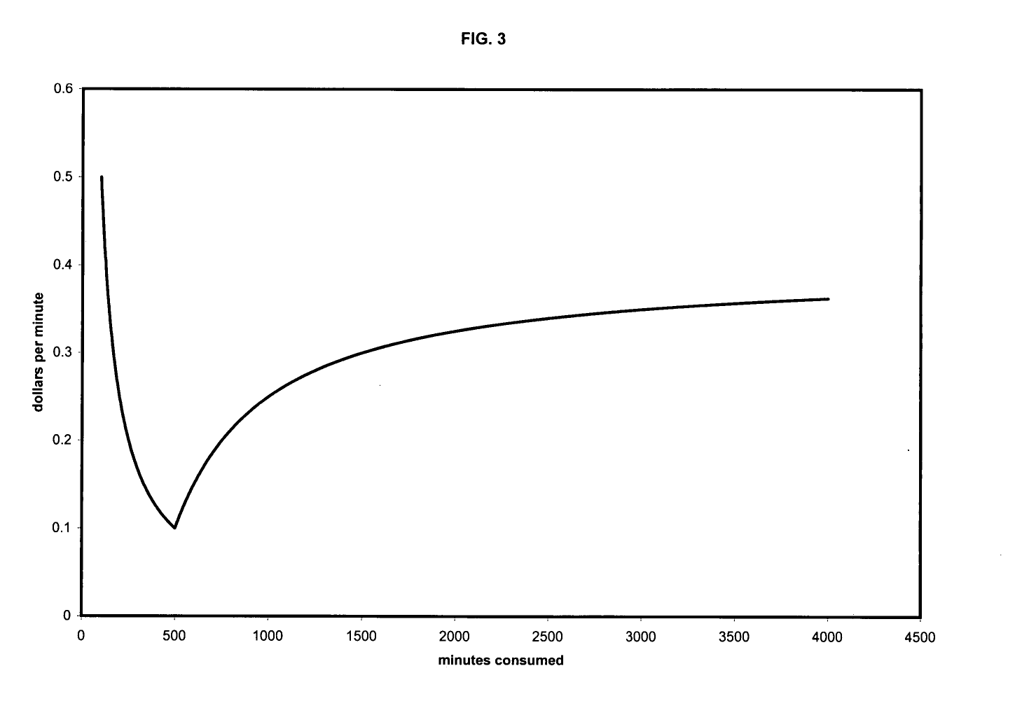

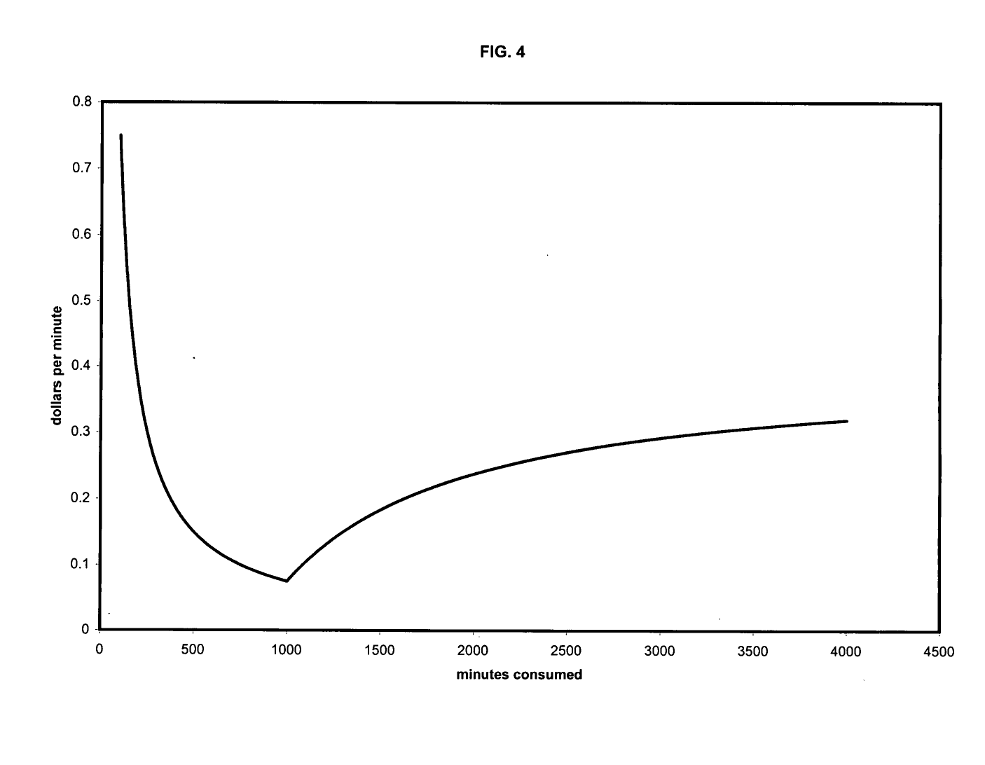

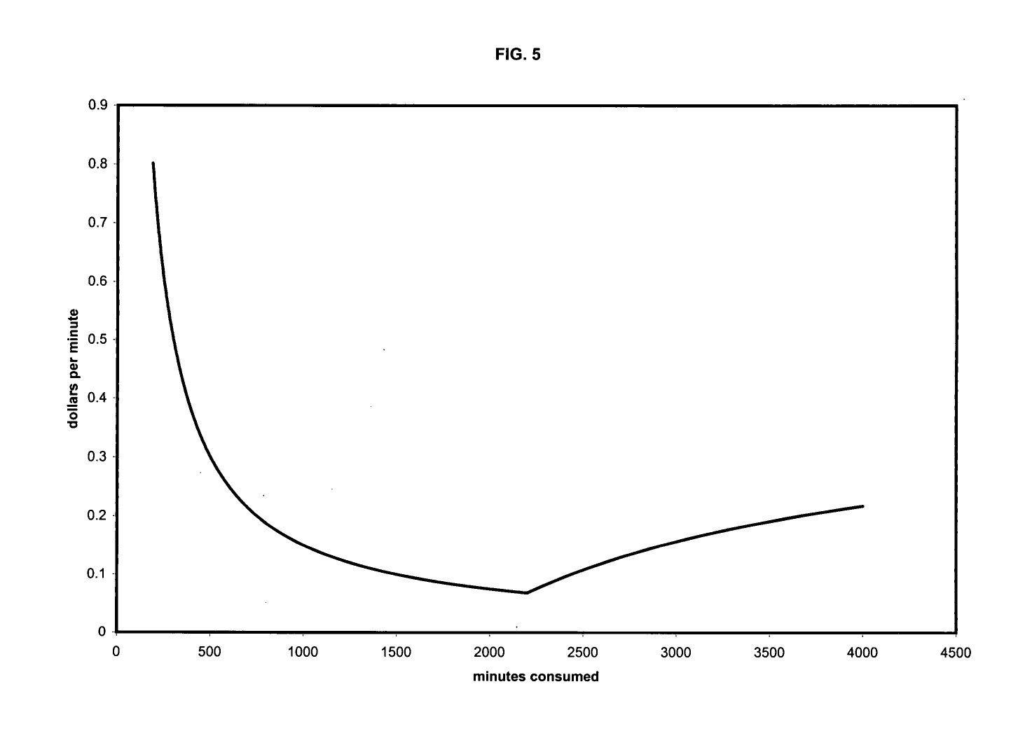

Similarly, graphical representations of the information contained in Table I for the other plans set forth in Table I may be shown, and these are set forth in FIGS. 3-7. One of ordinary skill immediately recognizes that the formulae inherent in the plan descriptions in Table I to the left of the minimum in the graphs is the basic plan amount divided by the minutes consumed, and to the right of the minimum the mathematically-equivalent expression is:
((((x−threshold level)*(0.4)))+plan amount)/x
in which x represents the minutes consumed and the * represents the multiplication operator.

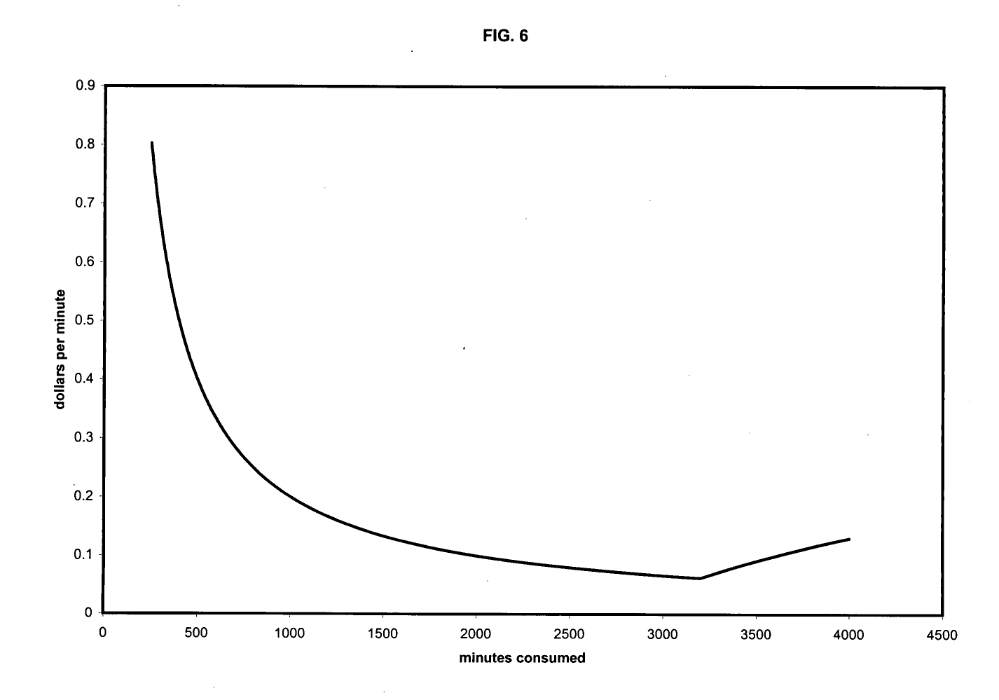

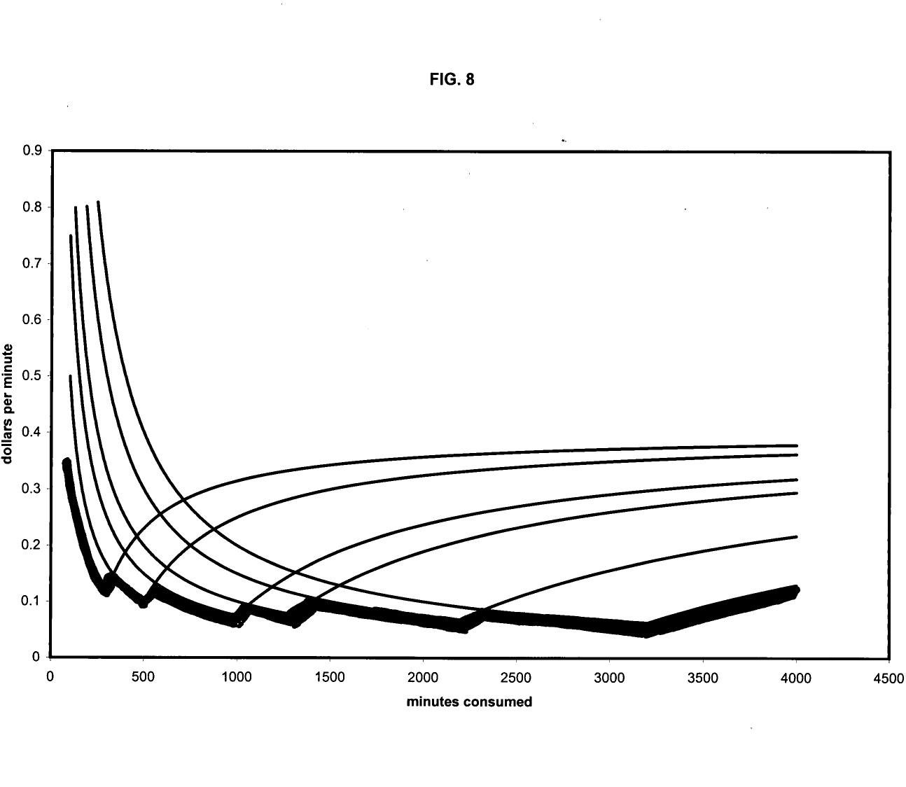

FIG. 8 shows the graphical equivalent representations for all of plans 1-6 superimposed on the same graph. Thus, FIG. 6 is the graphically-equivalent representation of the inherent feature of each of the plans specified in Table I.

The inventive principle of the present invention is rendered clear by the heavy line in FIG. 8. The heavy line in FIG. 8 contains points along all of the several billing graphs of plans 1-6 from Table I. This heavy line is arrived at by the teachings of the foregoing disclosure, i.e., by considering the invoice amount which a customer would have to pay under each of the plans for a given consumption level of minutes during the service interval, and then according to the invention selecting the plan having the lowest billing for that service interval out of all of the plans, over the entire range of possible consumption of minutes values within the service interval.

The heavy line in FIG. 8 is thus seen to be the graphical equivalent of the result of operating under a method according to the present invention.

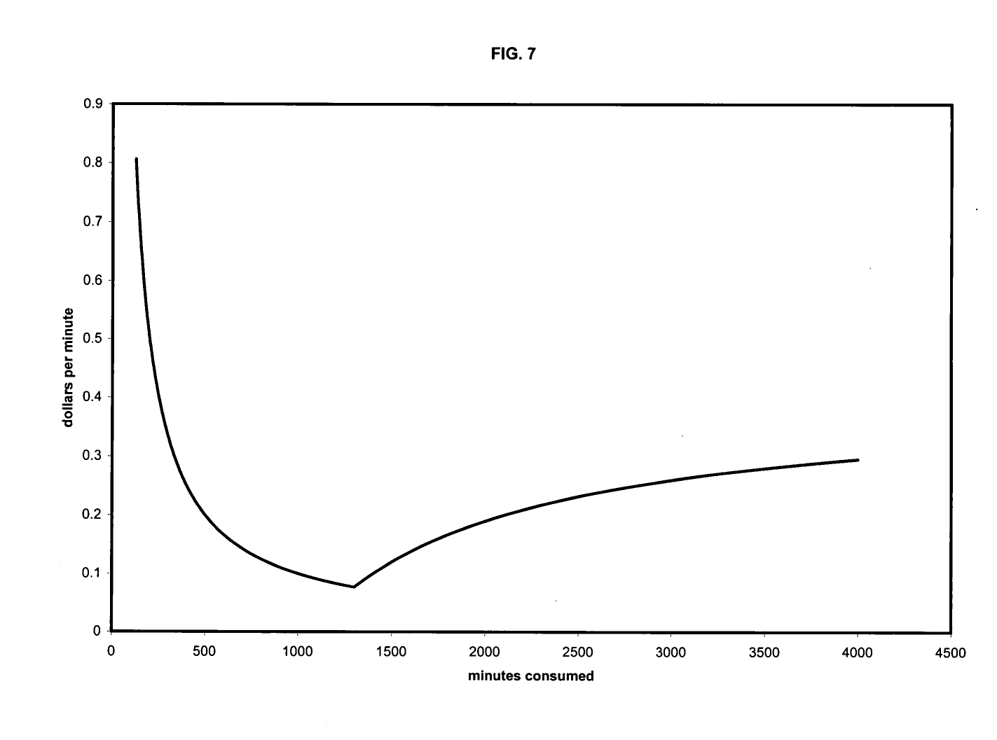

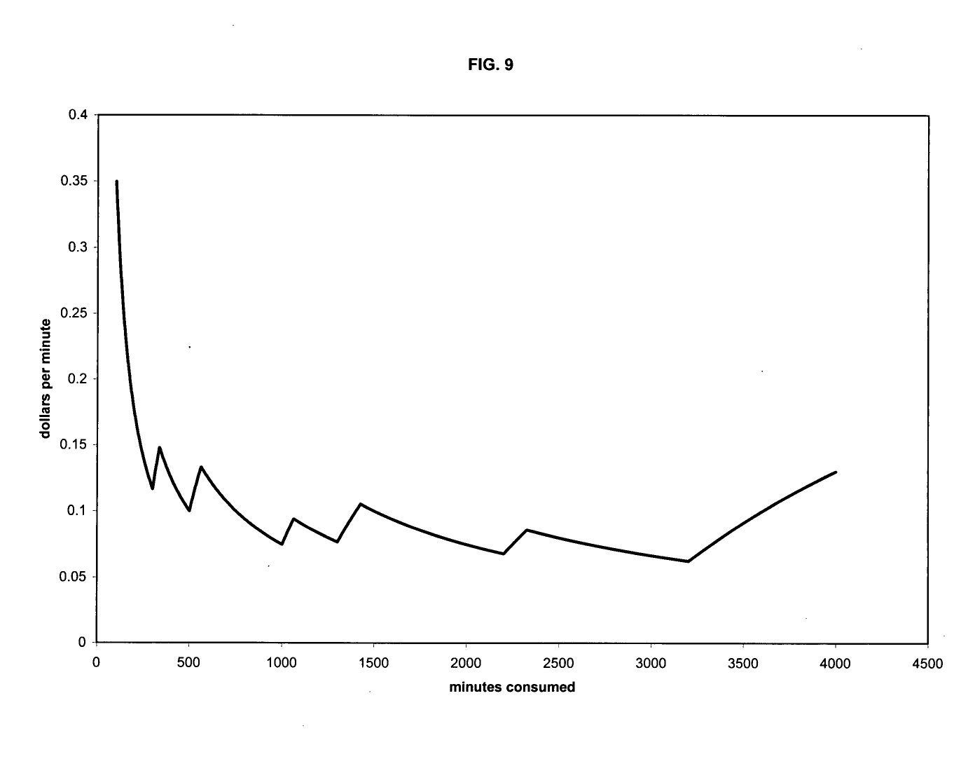

In FIG. 9 is shown the heavy line of FIG. 7 standing alone.

One of ordinary skill in the art immediately recognizes that the graph of the billing generated in accordance with the present invention in FIG. 9 includes as an inherent feature a plurality of discontinuities, which coincide with the minimums of each of the several billing plans from Table I. Thus, it is seen from FIG. 9 that the graph of the effective cost per minute of a billing plan according to the invention inherently includes a plurality of discontinuity points wherein a second discontinuity point has a y co-ordinate which is lower on the dollars per minute scale than a previous discontinuity point. It also includes subsequent discontinuity points that are successively lower on the dollars per minute scale than previous discontinuity points.

From FIG. 9 it is clear that this invention provides a billing method for cellular telephone services which is structured such that the cost per minute graph generated using the inventive method includes a first discontinuity, a second discontinuity, and a third discontinuity, wherein the billing rate per minute at said first discontinuity is higher than the billing rate per minute at the second discontinuity, wherein said first discontinuity occurs at a lower consumption level of minutes than said second discontinuity, and wherein the billing rate per minute at said second discontinuity is higher than the billing rate per minute of the third discontinuity, wherein said second discontinuity occurs at a lower consumption level of minutes than said third discontinuity. A discontinuity is a point on the dollars per minute graph of the plan at which the formula for calculating the dollars per minute changes.

It is also inherent in the features of Table I that the minimum of dollars per minute for plan 4 occurs at a higher level than the minimum of dollars per minute from plans 3 and 5. Thus, it is clear that this invention also provides a billing method for cellular telephone services which is structured such that its graph includes a first discontinuity, a second discontinuity, and a third discontinuity, wherein the billing rate per minute at said first discontinuity is higher than the billing rate per minute at the second discontinuity, wherein said first discontinuity occurs at a lower consumption level of minutes than said third discontinuity, and wherein the billing rate per minute at said second discontinuity is lower than the billing rate per minute of the third discontinuity, wherein said second discontinuity occurs at a lower consumption level of minutes than said third discontinuity.

Use of a variable billing method according to the invention would not only attract consumers away from competitors in the cellular service market, but would also save consumers money while not adversely impacting bandwidth usage, all while increasing consumer loyalty.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims which follow.

1) A method of providing cellular services in a market in which a plurality of billing plans are offered, which method takes into account the minutes of cellular service consumed by a consumer during a service interval and comprises the steps of:
a) offering consumers a billing plan having a cost per minute graph which includes a first discontinuity and a second discontinuity, wherein the billing rate per minute at said first discontinuity is higher than the billing rate per minute at said second discontinuity, and wherein the first discontinuity occurs at a minutes of consumption level which is less than the minutes of usage at which said second discontinuity occurs;
b) accepting a billing plan choice from at least one consumer;
c) providing cellular telephone service to the consumer over a service interval under said plan; and
d) charging the customer an invoice amount of at least the mathematical product of the number of minutes consumed by said consumer during said service interval multiplied by the dollars per minute cost of service associated with the level of consumption used by said consumer during said service interval on said cost per minute graph.

2) A method according to claim 1 in which the effective billing rate per minute of at least one of the billing plans offered by the provider continuously increases after reaching a threshold level.

3) A method according to claim 1 in which the cost per minute graph does not display a continuous increase in dollars per minute of service as the consumption increases after exhibiting a first discontinuity, wherein said first discontinuity occurs at about 300 minutes per month.

4) A method according to claim 1 in which the cost per minute graph exhibits a plurality of regions in which the dollars per minute value decreases as more minutes are consumed, subsequent to a first discontinuity in the cost per minute graph.

5) A method of providing cellular services in a market in which a plurality of billing plans are offered, which method takes into account the minutes of cellular service consumed by a consumer during a service interval and comprises the steps of:
a) offering consumers a billing plan having a cost per minute graph which includes a first discontinuity, a second discontinuity and a third discontinuity, wherein the billing rate per minute at said first discontinuity is higher than the billing rate per minute at the second discontinuity, wherein said first discontinuity occurs at a lower consumption level of minutes than said subsequent discontinuity, and wherein the billing rate per minute at said second discontinuity is higher than the billing rate per minute of the third discontinuity, wherein said second discontinuity occurs at a lower consumption level of minutes than said third discontinuity;
b) accepting a billing plan choice from at least one consumer;
c) providing cellular telephone service to the consumer over a service interval under said plan; and
d) charging the customer an invoice amount of at least the mathematical product of the number of minutes consumed by said consumer during said service interval multiplied by the dollars per minute cost of service associated with the level of consumption used by said consumer during said service interval on said cost per minute graph.

6) A method of providing cellular services in a market in which a plurality of billing plans are offered, which method takes into account the minutes of cellular service consumed by a consumer during a service interval and comprises the steps of:
a) offering consumers a plan having a cost per minute graph which includes a first discontinuity, a second discontinuity, and a third discontinuity, wherein the billing rate per minute at said first discontinuity is higher than the billing rate per minute at said second discontinuity, and wherein the billing rate per minute at said second discontinuity is higher than the billing rate per minute at said third discontinuity;
b) accepting a billing plan choice from at least one consumer;
c) providing cellular telephone service to the consumer over a service interval under said plan; and
d) charging the customer an invoice amount of at least the mathematical product of the number of minutes consumed by said consumer during said service interval multiplied by the dollars per minute cost of service associated with the level of consumption used by said consumer during said service interval on said cost per minute graph.

7) A method according to claim 6 wherein the first discontinuity occurs at a minutes of consumption level which is less than the minutes of minutes of consumption level at which said second discontinuity occurs, and wherein the second discontinuity occurs at a minutes of consumption level which is less than the minutes of consumption level at which said third discontinuity occurs.

8) A method according to claim 6 wherein the first discontinuity occurs at a minutes of consumption level which is less than the minutes of minutes of consumption level at which said second discontinuity occurs, and wherein the third discontinuity occurs at a minutes of consumption level which is greater than the minutes of minutes of consumption level at which said first discontinuity occurs but is less than the minutes of consumption level at which said second discontinuity occurs.

9) A method according to claim 6 wherein the second discontinuity occurs at a minutes of consumption level which is less than the minutes of minutes of consumption level at which said first discontinuity occurs and wherein the third discontinuity occurs at a minutes of consumption level which is greater than the minutes of minutes of consumption level at which said first discontinuity occurs.

10) A method useful for generating invoices under which customers of cellular telephone services may be billed which comprises the steps of:
a) offering a billing plan which features a cost per minute graph which includes a first discontinuity, a second discontinuity, and a third discontinuity, wherein the billing rate per minute at said first discontinuity is higher than the billing rate per minute at said second discontinuity, and wherein the billing rate per minute at said second discontinuity is higher than the billing rate per minute at said third discontinuity; and
b) multiplying the amount of minutes consumed by the consumer during a service interval by the cost per minute of service specified by said cost per minute graph associated with the number of minutes consumed by said consumer.

11) A method according to claim 10 wherein the level of minutes of cellular consumption at said first discontinuity is less than the level of minutes of cellular consumption at said second discontinuity, and wherein the level of minutes of cellular consumption at said second discontinuity is less than the level of minutes of cellular consumption at said third discontinuity.

12) A method according to claim 10 wherein the first discontinuity occurs at a minutes of consumption level which is less than the minutes of minutes of consumption level at which said second discontinuity occurs, and wherein the third discontinuity occurs at a minutes of consumption level which is greater than the minutes of minutes of consumption level at which said first discontinuity occurs but is less than the minutes of consumption level at which said second discontinuity occurs.

13) A method according to claim 10 wherein the second discontinuity occurs at a minutes of consumption level which is less than the minutes of minutes of consumption level at which said first discontinuity occurs and wherein the third discontinuity occurs at a minutes of consumption level which is greater than the minutes of minutes of consumption level at which said first discontinuity occurs.

14) A method useful for generating invoices under which customers of cellular telephone services may be billed which comprises the steps of:
a) offering a billing plan which features a cost per minute graph that exhibits a plurality of regions in which the dollars per minute value decreases subsequent to a discontinuity in the cost per minute graph, wherein said plurality of regions are separated by at least one discontinuity point; and
b) multiplying the amount of minutes consumed by the consumer during a service interval by the cost per minute of service specified by said cost per minute graph associated with the number of minutes consumed by said consumer.

15) A method useful for generating invoices under which customers of cellular telephone services may be billed which comprises the steps of:
a) offering a billing plan which features a cost per minute graph that exhibits a plurality of regions in which the dollars per minute value decreases subsequent to a discontinuity in the cost per minute graph, wherein said plurality of regions are separated by at least two discontinuity points; and
b) multiplying the amount of minutes consumed by the consumer during a service interval by the cost per minute of service specified by said cost per minute graph associated with the number of minutes consumed by said consumer.

16) A method useful for generating invoices under which customers of cellular telephone services may be billed which comprises the steps of:
a) offering a billing plan which features a cost per minute graph in which the rate charged per minute of service decreases continuously as the number of minutes consumed increases over the range of consumption between 1500 minutes per month and 2200 minutes per month; and
b) multiplying the amount of minutes consumed by the consumer during a service interval by the cost per minute of service specified by said cost per minute graph associated with the number of minutes consumed by said consumer.

17) A method of advertising cellular telephone services which comprises the step of: offering a billing plan having a cost per minute graph which includes a first discontinuity and a second discontinuity, wherein the billing rate per minute at said first discontinuity is higher than the billing rate per minute at said second discontinuity, and wherein the first discontinuity occurs at a minutes of consumption level which is less than the minutes of usage at which said second discontinuity occurs.

18) A method of advertising cellular telephone services which comprises the step of: offering a billing plan having a cost per minute graph which includes a first discontinuity, a second discontinuity, and a third discontinuity, wherein the billing rate per minute at said first discontinuity is higher than the billing rate per minute at said second discontinuity, and wherein the billing rate per minute at said second discontinuity is higher than the billing rate per minute at said third discontinuity.

19) A method according to claim 18 wherein the level of minutes of cellular consumption at said first discontinuity is less than the level of minutes of cellular consumption at said second discontinuity, and wherein the level of minutes of cellular consumption at said second discontinuity is less than the level of minutes of cellular consumption at said third discontinuity.

20) A method according to claim 18 wherein the first discontinuity occurs at a minutes of consumption level which is less than the minutes of minutes of consumption level at which said second discontinuity occurs, and wherein the third discontinuity occurs at a minutes of consumption level which is greater than the minutes of minutes of consumption level at which said first discontinuity occurs but is less than the minutes of consumption level at which said second discontinuity occurs.

21) A method according to claim 18 wherein the second discontinuity occurs at a minutes of consumption level which is less than the minutes of minutes of consumption level at which said first discontinuity occurs and wherein the third discontinuity occurs at a minutes of consumption level which is greater than the minutes of minutes of consumption level at which said first discontinuity occurs.
